(19) United States
(12) Patent Application Publication
(10) Pub. No.: US 2006/0176381 A1
(43) Pub. Date: Aug. 10, 2006

(54) Multi-format camera head

(76) Inventor: Petrus Gijsbertus Maria Centen, Goirle (NL)

Correspondence Address: Joseph S Tripoli;Patent Operations, Thomson Licensing Inc, PO Box 5312, Princeton, NJ, 08543-5312, US

(21) Appl. No.: 10/516,984

(22) PCT Filed: May 27, 2003
(86) PCT No.: PCT/EP03/50200

§ 371 Date: Dec. 6, 2004

(30) Foreign Application Priority Data
Jun. 7, 2002 (EP) 02291422.0

(51) Int. Cl. H04N 5/335

(52) U.S. Cl. 348/294

(57) ABSTRACT

A multi-format camera head comprises a light-sensor array having light-sensitive elements arranged in a plurality of element lines, and element readout means connected to said light-sensor array for outputting a signal representative of a quantity of light received by elements of a number of contiguous element lines. The readout means is adapted to selectively set the number of element lines to 5·n or 6·n, n being an integer.

The present invention relates to a multi-format camera head, i.e. a camera head for generating TV image signals according to multiple standards.

There are several different colour TV standards in use today that differ from each other, among other aspects, by the number of lines per image they use. The earliest of these is the American NTSC standard, which has a vertical resolution of 480 or 483 lines; somewhat more recent are the European PAL and SECAM standards, both of which have 575 lines. The most recent digital standards (HDTV) have still higher line numbers of e.g. 1080.

If TV images are recorded using one of these standards, a subsequent transformation into another standard leads to a loss in image quality, aliasing effects etc. It is therefore desirable to record images from the start in the format in which they will be needed. The problem is that the hardware structure of an image sensor of a TV camera is adapted to the vertical resolution of a TV standard for which it is designed, and it is not straightforwardly possible to switch over from one standard to another in a single camera.

This problem was addressed in U.S. Pat. No. 4,426,664. This document describes a CCD (charge coupled device) image sensor which is adapted to generate a television image signal according to NTSC, PAL, or SECAM standards. A CCD is a semiconductor device having a surface in which electron-hole pairs are generated by incident light. The surface is generally structured into a plurality of columns in such a way that photoelectrons generated in one column cannot move into an adjacent one. Perpendicular to the columns, a plurality of electrodes extend across the surface by which a potential well can be applied that attracts the photoelectrons, or a barrier potential can be applied that prevents the electrons from moving from one potential well to the next along the columns. These electrodes form a periodic pattern of wells and barriers along the columns. Operation of the CCD comprises two phases, an integrating phase and a readout phase. In the integrating phase, the potentials at the individual electrodes are held constant, so that the potential wells do not move and can accumulate photoelectrons. Each potential well and the barriers around it thus correspond to one pixel. In the readout phase the pattern of well and barrier potentials is shifted along the columns so that the accumulated charges are displaced to an edge of the sensitive surface and are extracted there. In order to be able control the direction of displacement of the electrons, one pixel must be at least three electrodes wide.

The sensitive surface of the sensor of U.S. Pat. No. 4,426,664 is divided into about 570 lines according to the vertical resolution of PAL and SECAM standards and a plurality of columns, the lines each having a length conforming to the aspect ratio of these standards. When this sensor is used for generating an NTSC signal, readout is confined to the bottom 480 lines of the sensor (i.e. the lines closest to a line transfer register), and, in order to achieve a correct aspect ratio, to only part of its columns.

This solution is not entirely satisfying. First, the active surface of the sensor is reduced when generating an NTSC signal. Further, the centres of the image are different when generating NTSC images, on the one hand, and PAL or SECAM images, on the other. Only one image can have its centre on the optical axis of a camera lens and thus have a good imaging quality, whereas the other image may suffer from a distortion.

One might consider modifying the readout circuitry of U.S. Pat. No. 4,426,664 in such a way that the surface regions of the sensor that are not read out in NTSC mode surround the read-out area at all sides, so that both images have their centre on the optical axis, but this would increase readout circuit complexity considerably, and still, switching over from one standard to the other would also amount to modifying the zoom factor of the camera lens, which is also undesirable.

A viable solution to this problem for NTSC and HDTV standards was presented at the 142d SMPTE conference, October 2000, in a paper entitled “A Multi-Format Camera Head”, by P. Centen et al. The authors suggest determining the line number of a CCD device for multi-format imaging by the least common multiple of the line numbers of the formats to be generated. In the camera head of this paper, a CCD device having 4320 lines is used for generating progressive or interlaced images having 1080, 720 or 480 lines by deriving one line of the image signal from three, four or six CCD lines each.

The least common multiple of 480 and 575 is 55200. Applying the solution to a camera head for generating NTSC and PAL (or SECAM) images would require an image sensor having the prohibitively high number of 55200 lines.

In view of this, the present invention notably seeks to provide a simple and economic camera head for generating NTSC and PAL (or SECAM) images in which the light-sensitive surfaces used for generating the two types of image format are not noticeably different.

The invention proposes a camera head comprising a light-sensor array having light-sensitive elements arranged in a plurality of element lines, element readout means connected to said light-sensor array for outputting a signal representative of a quantity of light received by elements of a number of contiguous element lines, wherein said readout means is adapted to selectively set the number of element lines to 5·n or 6·n, n being an integer.

The present invention relies on the finding that the least common multiple of 480 and 576 is only 2880, i.e. it is little more than 1/20 of 55200, and that the ratio of 480 to 576 is exactly 5 to 6. Accordingly, from a light sensor array having a given number of element lines, an NTSC image can be derived by combining the detection results of light-sensitive elements of 6·n adjacent element lines into a line image signal representing one horizontal line of the NTSC image, n being an integer, preferably one (1), whereas for generating a PAL or SECAM image, the number of element lines to be combined is 5·n.

For generating interlaced images, half of the least common multiple, i.e. 1440 element lines are sufficient.

The sensor array of the camera head may be a CCD device or a CMOS device.

As is known in the art of CCD-design, a CCD light-sensor array may comprise light-insensitive element lines for temporarily storing charges accumulated in the light-sensitive elements. Such an array may be of the frame transfer type or the interline type.

In such a CCD device, the light-sensitive elements are in general arranged in a plurality of columns and said readout means comprise at least one shift register having a register cell connected to each of said columns for receiving a photocharge accumulated in light-sensitive elements of said column, and there is a drive circuit for displacing the photocharge across the light-sensor array towards the shift register.

There are several possibilities for combining the detection results of five or six element lines. One is to accumulate photocharges from a plurality of light-sensitive elements in one register cell. This can be done by propagating charges from five or six element lines successively into a shift register, so that finally, each of the cells of this shift register holds charges from five or six light-sensitive elements of one column, and then outputting the charge accumulated in the shift register. To this end, the element readout means preferably comprise at least one electrode connected to each element line, a clock generator for cyclically applying a potential to said electrodes which is effective to displace an electrical charge from one element line to an adjacent element line and from a last one of said element lines to the register cells of said shift register, and shift register driving means for serially outputting charges contained in each of said shift register cells, and the shift register driving means are adapted to output said charges once in a selected plural number of cycles of said clock generator.

Accumulation of photocharges can also be carried out while propagating these from the light-sensitive elements to the shift register cells. For this purpose, the clock generator is preferably further adapted to apply a potential for displacing charges from elements of a first element line to elements of an adjacent second element line while keeping in place charges present in the elements of said second element line. In case that the CCD device is of the frame transfer type, it is preferred that said first element line is a light sensitive element line and the second element line is a light-insensitive element line. This has the advantage that there may be less light-insensitive than light-sensitive element lines, whereby cost of the CCD device can be reduced.

Differently said, the invention proposes a camera head comprising a light-sensor array comprising light-sensitive elements arranged as a matrix having a number of element lines between 1440.i.j and 1458.i.j (i and j being integers), preferably 1440.i.j, and readout means operable in a first mode to generate a first video signal having 240.i or 241.i or 242.i or 243.i signal lines (preferably 240.i), each line being generated from light-sensitive elements of 6.j adjacent element lines, and in a second mode to generate a second video signal having 288.i signal lines, each line being generated from light-sensitive elements of 5.j adjacent element lines.

Advantageously, control means allows to select operation of the readout means in a mode of a list of modes comprising the first mode and the second mode.

Further features and advantages of the invention will become apparent from the subsequent description of some of its embodiments referring to the appended drawings. In these:

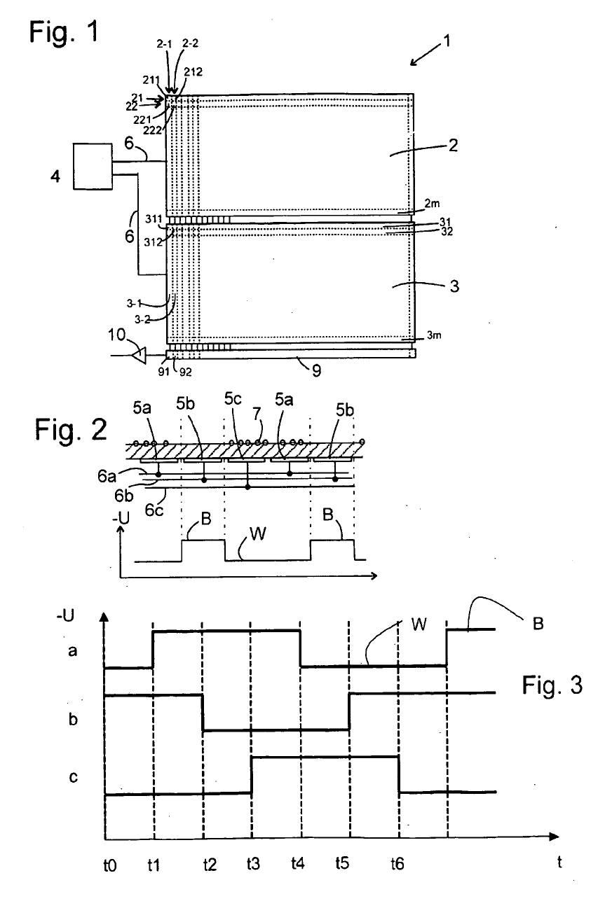

FIG. 1 is a block diagram of a frame transfer CCD device according to a first embodiment of the invention;

FIG. 2 is an enlarged cross section of the device of FIG. 1;

FIG. 3 is a timing diagram of the readout means of the device of FIG. 1;

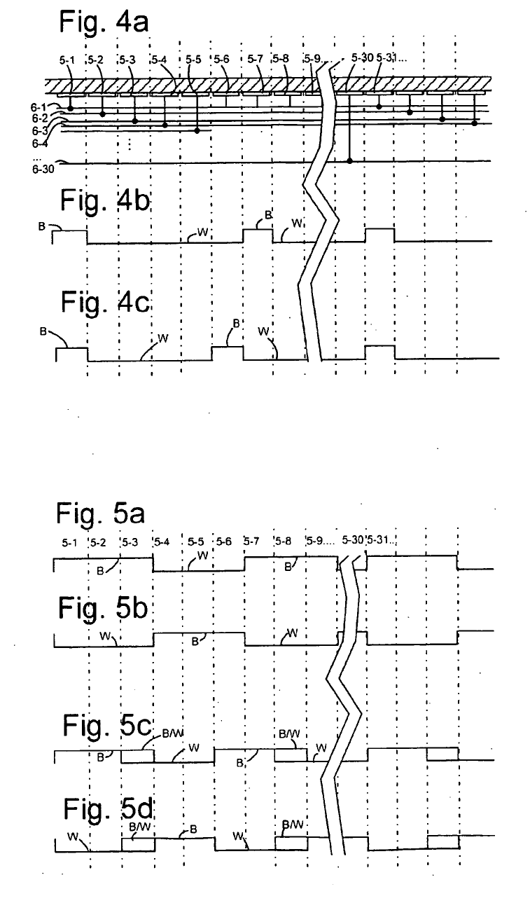

FIG. 4a is a cross section analogous to that of FIG. 2, according to a second embodiment of the invention;

FIGS. 4b, 4c show potential distributions in the cross section of FIG. 4a when operating in NTSC and PAL/SECAM modes, respectively;

FIGS. 5a to 5d illustrate generation of interlaced images in the second embodiment;

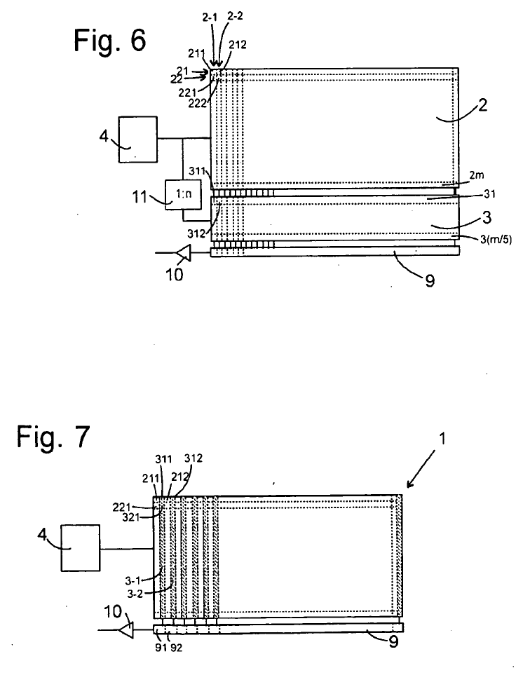

FIG. 6 is a block diagram of a frame transfer CCD device according to a fourth embodiment of the invention;

FIG. 7 is a block diagram of an interline or frame interline CCD according to a fifth embodiment of the invention.

In FIG. 1, reference numeral 1 denotes a CCD device of the frame transfer type for a camera head according to the present invention. The CCD device 1 has a light sensitive surface portion 2 onto which an image to be recorded is projected and in which m=1440 parallel element lines 21, 22 are formed. The device of the present example is a three-phase device; i.e. each element line comprises three electrodes, not shown, extending across surface portion 2, so that there are 4320 electrodes in total. All element lines 21, 22 . . . , are subdivided along these electrodes into 1920 elements 211, 212, . . . ,221,222, . . . that contribute to the image signal output by the camera head plus eventually some additional elements that do not contribute to the image signal but are required for run-in of filters in contour processing of the image signal. The elements of one element line are electrically isolated from each other. Similarly, a light-insensitive surface portion 3 is structured into 1440 element lines 31, 32, . . . having the same number of elements 311, 312, . . . as the element lines of light-sensitive portion 2.

The light-sensitive and light-insensitive elements 211, 212, . . . ,311, 312, . . . are arranged in columns 2-1,2-2, . . . 3-1, 3-2, . . . . Each column comprises one element in each element line, and in each column, elements of adjacent lines are conductively coupled so that charges may move from an element of one line to that of the other, from the bottom line 2m of portion 2 to the uppermost line 31 of portion 3 and from the bottom line 3m of portion 3 into cells 91, 92, . . . . of a shift register 9, if appropriate bias voltages are applied to the electrodes of these lines.

A control circuit 4 provides these bias voltages to the electrodes by bias supply lines jointly referred to by reference numeral 6.

FIG. 2 is a partial cross section of the CCD 1 in a direction perpendicular to the electrodes and a graph of the potential distribution along this cross section. Five of these electrodes, designated 5a, 5b, 5c, 5a, 5b are shown in FIG. 2. There are three bias supply lines 6a, 6b, 6c, each connecting 5a, 5b or 5c electrodes with the control circuit 4. Photoelectrons 7 are shown above the 5a and 5c electrodes, because at the instant shown, these electrodes receive a positive bias voltage with respect to the 5b electrodes and thus form a potential well W that attracts electrons 7 while the 5b electrodes form a barrier B for the electrons 7. A set of three contiguous electrodes thus defines one element line.

In operation, integration and readout phases of the CCD 1 alternate. In the integration phases, light incident on surface portion 2 generates photoelectrons 7 that accumulate in the nearest potential well W.

In a first part of the readout phase, control circuit 4 applies rapidly varying bias potentials to the electrodes 5 of surface portions 2 and 3, as shown in FIG. 3. In a first stage from t0 to t1, potential wells W are applied to 5a and 5c electrodes, and a barrier potential B to the 5b electrodes. In a first intermediate stage, from t1 to t2, a barrier potential is applied to electrode 5c. In a second stage from t2 to t3, the potential well W is applied to the 5b electrode. The charges at the respective electrodes are displaced by one electrode, i.e. one third of an element line. In a second intermediate stage, from t3 to t4, a barrier potential is applied to electrode 5c. In a third stage from t4 to t5, 5c electrode still receives the barrier potential B and 5a and 5b are at potential well W. Charges move by another third of an element line. At t5, electrode potentials become the same again as at t0; the charges are displaced by one element line in total, and a charge displacement cycle is complete. By carrying out 1440 such cycles, the charge distribution that has accumulated in the light-sensitive elements of portion 2 during the integration phase is transferred to the elements of insensitive portion 3. As soon as this transfer is complete, a new integration phase can begin in the light-sensitive portion 2.

In a second part of the readout phase, simultaneously with the new integration phase, the charge distribution stored in the elements of portion 3 is converted into a serial signal. By applying a charge displacement cycle as described above to the electrodes of portion 3 only, charges from the bottom element line 3m of portion 3 are transferred into shift register 9.

Conventionally, the control circuit 4 would control the shift register to output the charges received by it serially to an on-chip-amplifier 10 once after every charge displacement cycle in the second part of the readout phase. According to the present invention, however, if the control circuit is set to generate an NTSC image signal, it carries out six such charge displacement cycles before reading out the shift register 9, and if the signal to be generated is a PAL or SECAM signal, the number of charge displacement cycles is five. Thus, charges from six or five image elements, respectively, of contiguous element lines accumulate in each cell 91,92 . . . of shift register 9 and are output as one value to amplifier 10.

According to the embodiment of FIGS. 1 to 3, there are three bias supply lines 6, the bias potentials of which are controlled individually by control circuit 4. In a modification of this embodiment in which the number of electrodes per element line is four, it is easily recognized that interlaced images may be generated by dividing the electrodes into sets of two adjacent electrodes each and, in a first integrating phase, applying the barrier potential B to every first, third, fifth, . . . set and the potential well W to second, fourth etc. sets, and in a subsequent integrating phase, applying the barrier potential B to second, fourth etc. sets and the potential well W to the first, third, fifth set and so on. It should be noted, however, that generation of interlaced images is also possible using three-electrode element lines as described above based on a procedure disclosed in European patent application 0 523 781. Said published EP Application discloses a 3-phase charge coupled imaging device in which two rasters sensed consecutively are effectively shifted relative to one another over a distance of half a pixel in that the charge is shifted to and fro in the integration period, so that the location of the center of gravity of the pixel is determined by the direction in which the charge is shifted and by the duration of storage of the charge in a certain location. By displacing the charge in a different direction in the first half raster compared with the other half raster it is possible, as calculations show, to shift the center of gravity of a certain pixel over a distance of half a pixel i.e. over a distance of 1.5 electrode, relative to the other half raster.

According to another preferred embodiment shown in cross section in FIG. 4a there are thirty supply lines 6-1, 6-2, . . . 6-30 and there is only one electrode per element line. If the electrodes are consecutively numbered 5-1, 5-2, a first supply line 6-1 is connected to electrodes 5-1, 5-31, 5-61, . . . , a second one 6-2 to electrodes 5-2, 5-32, 5-62, . . . and so on. In this embodiment, when generating an NTSC signal, the 30 supply lines 6-1, 6-2, . . . are divided into five groups of six, and by five of these lines, five contiguous electrodes 5-2, . . . , 5-6 are supplied with a potential well W, whereas the remaining electrode 5-1 receives the barrier potential B. Such a potential distribution is shown in FIG. 4b. For PAL or SECAM, the division is in six groups of five electrodes, four of which (5-2, . . . , 5-5) receive the potential well W, whereas the remaining one 5-1 receives the barrier potential B, as shown in FIG. 4c. By shifting the electrodes that receive the barrier potential B across the surface of the CCD 1 in analogy to what was described above with respect to FIG. 3, charges can be read out from the device. Since in this embodiment the number of electrodes per line element is reduced by a factor of three, at the expense of a somewhat increased complexity of the control circuit, the size of the light-sensitive portion required for a given resolution is considerably reduced.

FIGS. 5a to 5d illustrate generation of interlaced NTSC and PAL/SECAM images using the CCD 1 of FIG. 4a. In NTSC mode, in a first integrating phase control circuit 4 applies barrier potential B to groups of three electrodes 5-1, 5-2, 5-3; 5-7, 5-8, 5-9; . . . , whereas electrodes 5-4, 5-5, 5-6; 5-10, 5-11, 5-12 . . . receive the potential well W. The charges collected in the potential wells thus primarily reflect light intensities incident on electrodes 5-4 to 5-6 etc. When the CCD is read out in groups of six electrodes as described above, a first frame corresponding to lines 2, 4, 6 etc. of the NTSC image is obtained.

In a second integrating phase, bias voltages at the electrodes are reversed as shown in FIG. 5b, so that charges are primarily collected from the surface corresponding to electrodes 5-1 to 5-3, 5-7 to 5-9 etc. When reading out, a second frame corresponding to lines 1, 3 . . . etc. of the NTSC image is obtained.

In PAL/SECAM mode, in a first integrating phase shown in FIG. 5c, barrier potential B is applied to electrodes 5-1, 5-2, 5-7, 5-8 etc., and potential well W is applied to electrodes 5-4, 5-5, 5-9, 5-10 etc. Electrodes 5-3, 5-8 are well and barrier potentials applied to them during 40% and 60% of the integrating phase, respectively. Reading out the CCD in groups of five electrodes gives even numbered lines of a PAL/SECAM image.

In a second integrating phase, bias voltages are reversed as shown in FIG. 5d, so that odd-numbered lines of the PAL/SECAM image are obtained, but the application of the well and barrier potentials during 40% and 60% respectively is maintained. Through that specific ratio for well and barrier potentials during the integrating phase, proper interlacing is obtained.

According to a third preferred embodiment not shown in a drawing, the number of individually controlled bias supply lines 6 may be 12. In that case, three electrodes will form one element line for NTSC, PAL and SECAM imaging, as in the embodiment of FIGS. 1 to 3, so that the size of the light-sensitive portion can not be made smaller than in this embodiment. The interest in using twelve bias lines is that by these, 4320 electrodes can be divided into 1080 groups of four each or 720 groups of 6 each, for generating, in addition to PAL, NTSC and SECAM signals, HDTV images at 1080 or 720 lines vertical resolution.

In the above embodiments, it has been assumed that for every light sensitive element of portion 2, there is a light insensitive element in portion 3 to which the charge accumulated in the light sensitive element during an integration phase is transferred in the first part of the readout phase, and that from these elements, the charges are transferred element line by element line to the shift register 9, so that accumulation of charges from several element lines takes place in the shift register 9.

Of course, accumulation of the charges might already take place at an earlier stage of their transfer from the light-sensitive portion 2 to shift register 9. This can be achieved by selecting one element line through which all charges must transit on the way to shift register 9, and by setting transfer speed in a region of CCD device 1 upstream of the selected line higher than downstream of this line. This concept is explained in detail referring to the block diagram of FIG. 6. Elements of this embodiment that are also shown in FIGS. 1 to 3 have the same reference numerals as above and are not explained in detail again.

In the embodiment of FIG. 6, control unit 4 is adapted to cyclically supply bias potentials to electrodes of light-sensitive portion 2 in the first part of the readout phase with a cycle duration T, so that in a time T, charges in light sensitive portion are displaced by one element line.

At the same time, the control unit supplies bias potentials to electrodes of the light-insensitive portion 3 with a cycle duration of nT, n being either 5 if PAL or SECAM signals are to be generated, or 6 if NTSC signals are to be generated. In FIG. 4, this fact is symbolized by a frequency divider 11 in bias supply lines 6 between control unit 4 and light-insensitive portion 3, but of course, there might as well be two control circuits for generating bias voltages for the two portions 2, 3 at different rates, or there might be one control circuit generating both sets of bias voltages.

In the PAL/SECAM operating mode, in the first part of a readout phase charges from five element lines of portion 2 will be dumped into the top line 31 of portion 3, before these charges are displaced downwards by one element line in portion 3. Accordingly, the number of element lines in the light-insensitive portion 3 may be five times less than the number m of element lines in the light-sensitive portion 2. If interlaced images are generated, 288 element lines are sufficient in portion 3.

In the NTSC operating mode, the top line 31 of portion 3 will accumulate charges from six element lines of portion 2, before these charges are displaced downwards by one element line in portion 3. I.e. progress of the charges through the insensitive portion 3 is slower than in PAL/SECAM mode, and if the number of element lines in portion 3 is set such that it is just sufficient in PAL/SECAM mode, the bottom sixth of the insensitive portion 3 will be left empty when an image has been transferred to it in NTSC mode. Accordingly, in NTSC mode, the control unit 4 carries out a number of extra charge transfer cycles in order to make sure that when the second part of the readout phase begins, charges representing image data will be available in the bottom element line 3(m/5) of portion 3.

The invention is also applicable to CCD devices of the Interline (IT) or Frame Interline (FIT) type. A block diagram of a camera head comprising such a CCD device 1 is shown in FIG. 7. In such a device, light-sensitive elements 211, 212, . . . , 221, 222, . . . and light-insensitive elements 311, 312, . . . ; 321, 322, . . . are arranged in an alternating manner in a same element line 21, 22, . . . . The CCD 1 is operated by shifting all charges accumulated in the light-sensitive elements 211, 212, . . . in an integrating phase to a neighbouring light-insensitive element 311, 312, . . . and, by applying appropriate bias voltages to electrodes of the light-insensitive elements 311, 312, . . . , displacing these charges element line by element line along the columns 3-1, 3-2 of light-insensitive elements to shift register 9. Just as described above referring to the first embodiment of FIGS. 1 to 3, sets comprising charges from five or six contiguous element lines can be obtained by transferring charges from five or six consecutive element lines to shift register 9 and then outputting the charges accumulated in each of its cells 91, 92 . . .

According to another embodiment, not shown, charges output by a CMOS image sensor are distributed to several column amplifiers, and a sum of charges simultaneously output from these column amplifiers is formed using an adding circuit.

Although the readout procedure in a CMOS image sensor is different from that of the CCD sensor, it should be obvious that the general idea of the present invention to selectively read out light-sensitive elements of contiguous lines of the sensor in groups of five or six for generating a PAL/SECAM or NTSC image is straightforwardly applicable to a CMOS device as well.

1. A camera head comprising
a light-sensor array having light-sensitive elements arranged in a plurality of element lines,
element readout means connected to said light-sensor array for outputting a signal representative of a quantity of light received by elements of a number of contiguous element lines,
wherein
said readout means is adapted to selectively set the number of element lines to 5·n or 6·n, n being an integer.

2. The camera head of claim 1, wherein the number of element lines is 1440 or an integer multiple thereof.

3. The camera head of claim 1, wherein the light-sensor array is a charge-coupled device.

4. The camera head of claim 3, wherein the light sensor array further comprises element lines formed of light-insensitive elements.

5. The camera head of claim 3, wherein said light-sensitive elements are further arranged in a plurality of columns and said readout means comprises at least one shift register having a register cell connected to each of said columns for receiving a photocharge accumulated in light-sensitive elements of said column, and a drive circuit for displacing the photocharge along the columns towards the shift register.

6. The camera head of claim 5, wherein the drive circuit is adapted to accumulate photocharges from a plural number of light-sensitive elements in one register cell.

7. The camera head of claim 6, wherein the element readout means comprise at least one electrode connected to each element line, a clock generator for cyclically applying a potential to said electrodes which is effective to displace an electrical charge from one element line to an adjacent element line and from a last one of said element lines to the register cells of said at least one shift register, and shift register driving means for serially outputting charges contained in each of said shift register cells, and wherein the shift register driving means are adapted to output said charges once in a selected plural number of cycles of said clock generator.

8. The camera head of claim 7, wherein the clock generator is further adapted to apply a potential for displacing charges from a first element line to an adjacent second element line while keeping in place charges present in said second element line.

9. The camera head of claim 8, wherein light insensitive element lines are arranged as a block between a block comprising the light sensitive element lines, on the one hand, and said first element line is a light sensitive element line and the second element line is a light-insensitive element line.

10. The camera head of claim 5, further comprising an adding circuit connected to the output of said at least one shift register for adding charges output from a selected plural number of light-sensitive elements of a same column.

11. The camera head of claim 10, wherein the number of shift registers is six.

12. The camera head of claim 6, wherein the plural number is selected among 5 and 6.

13. The camera head of claim 1, wherein the light-sensor array is a CMOS device.

14. A method of obtaining an NTSC image signal from a light-sensor array having light-sensitive elements arranged in a plurality of element lines, wherein an image line signal representative of a quantity of light received by elements of a number of contiguous element lines is formed and the NTSC image signal is derived from said image line signal, wherein the number is 6·n, n being an integer.

15. A method of obtaining a PAL or SECAM image signal from a light-sensor array having light-sensitive elements arranged in a plurality of element lines, wherein an image line signal representative of a quantity of light received by elements of a number of contiguous element lines is formed and the PAL or SECAM image signal is derived from said image line signal, wherein the number is 5·n, n being an integer.

16. A method of obtaining an NTSC image signal from a light-sensor array having light-sensitive elements arranged in a plurality of element lines, wherein an image line signal representative of a quantity of light received by elements of a number of contiguous element lines is formed and the NTSC signal is derived from said image line signal, wherein the number is 3·n, n being an integer.

17. A camera head comprising:
a light-sensor array Comprising light-sensitive elements arranged as a matrix having 1440.i.j element lines, i and j being integers,
readout means operable in a first mode to generate a first video signal having 240.i signal lines, each line being generated from light-sensitive elements of 6.j adjacent element lines, and in a second mode to generate a second video signal having 288.i signal lines, each line being generated from light-sensitive elements of 5.j adjacent element lines.

18. The camera head of claim 17, wherein control means allows to select operation of the readout means in a mode of a list of modes comprising the first mode and the second mode.

19. A camera head comprising:
a light-sensor array Comprising light-sensitive elements arranged as a matrix having a number of element lines between 1440.i.j and 1458.i.j, i and j being integers,
readout means operable in a first mode to generate a first video signal having 240.i or 241.i or 242.i or 243.i signal lines, each line being generated from light-sensitive elements of 6.j adjacent element lines, and in a second mode to generate a second video signal having 288.i signal lines, each line being generated from light-sensitive elements of 5.j adjacent element lines.

20. The camera head of claim 19, wherein control means allows to select operation of the readout means in a mode of a list of modes comprising the first mode and the second mode.
